(19) United States
(12) Patent Application Publication
(10) Pub. No.: US 2009/0061265 A1
(43) Pub. Date: Mar. 5, 2009

(54) FUEL PROCESSOR COMPRISING SHIFT REACTOR HAVING IMPROVED WARMING UP STRUCTURE AND METHOD OF OPERATING THE SAME

(75) Inventors: Hyun-chul Lee, Hwaseong-si (KR); Doo-hwan Lee, Suwon-si (KR); Kang-hee Lee, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/018,979

(22) Filed: Jan. 24, 2008

(30) Foreign Application Priority Data
Aug. 27, 2007 (KR) 2007-86279

(51) Int. Cl. H01M 8/06

(52) U.S. Cl. 429/17; 429/19

(57) ABSTRACT

Provided is a fuel processor in a fuel cell system having a shift reactor with an improved warming up structure and a method of operating the fuel cell system. The fuel processor includes a combustion reactor for rapidly increasing the temperature of the shift reactor. The combustion reactor is installed to contact an outer circumference of the shift reactor and includes a combustion catalyst disposed along a gas flow channel formed therein. In the fuel processor, the shift reactor can be rapidly heated by the combustion reactor that contacts the shift reactor using an exothermic reaction of the combustion catalyst disposed in the combustion reactor. Therefore, a warming-up time required for the fuel processor to reach a normal operation in an initial start-up can be greatly reduced.

### CROSS-REFERENCE TO RELATED PATENT APPLICATION

This application claims the benefit of Korean Patent Application No. 10-2007-0086279, filed on Aug. 27, 2007, in the Korean Intellectual Property Office, the disclosure of which is incorporated herein in its entirety by reference.

### BACKGROUND OF THE INVENTION

1. Field of the Invention

The present invention relates to a fuel processor that reforms a fuel to be suitable for supplying to a fuel cell, and more particularly, to a fuel processor having a shift reactor with an improved warming up structure and a method of operating the fuel processor.

2. Description of the Related Art

A fuel cell is an electric generator that changes chemical energy of a fuel into electrical energy through a chemical reaction. FIG. 1 is a schematic drawing illustrating the energy transformation structure of a fuel cell. Referring to FIG. 1, when air that includes oxygen is supplied to a cathode 1 and a fuel containing hydrogen is supplied to an anode 3, electricity is generated by a reversible reaction of water electrolysis through an electrolyte membrane 2. However, a unit cell 4 does not generally produce a voltage that is high enough to be used. Therefore, electricity is generated by a stack in which a plurality of unit cells 4 is connected in series.

FIG. 2 is a schematic drawing of the structure of a fuel processor 10 for supplying hydrogen to an anode of a fuel cell. Hydrogen extracted from a hydrocarbon group material fuel source such as a natural gas is supplied to the stack.

The fuel processor 10 includes a desulfurizer 11, a reformer 12, a reformer burner 13, a water supply pump 16, first and second heat exchangers 14a and 14b, and a CO remover unit 15 consisting of a CO shifter 15a and a CO remover 15b.

The desulfurizer 11 removes sulfur components which are used as an odorant in the hydrocarbon group material fuel source since the sulfur components are a catalyst poison of a platinum group catalyst used in the fuel processor 10 and the stack. The reformer 12 extracts hydrogen from the desulfurized hydrocarbon group material fuel source. Hydrogen supplied to the stack by the fuel processor 10 is extracted from the desulfurized hydrocarbon group material fuel source.

However, a large amount of carbon monoxide is included in a gas generated from the reformer 12, and this large amount of carbon monoxide reduces the efficiency of the platinum group catalyst used in the fuel processor 10 and the stack. Thus, the gas is supplied to the stack after reducing the content of carbon monoxide to 10 ppm through the CO shifter 15a and the CO remover 15b.

When the fuel processor 10 starts after a long shutdown, since the reformer 12 and the CO shifter 15a are at room temperature, the fuel processor 10 is unable to instantly enter into normal operation, and can only perform a normal function after a few hours of heating. At this point, the CO shifter 15a is more of a problem than the reformer 12. That is, the temperature of the reformer 12 can be increased to a desired level in a short time by directly heating with the burner 13, but the CO shifter 15a requires time to reach a normal operating temperature since the CO shifter 15a is indirectly heated by a fuel gas entering from the reformer 12. Considering that a typical normal operating temperature of the reformer 12 is approximately 700° C. and that of the CO shifter 15a is approximately 200° C., it takes only approximately 20 minutes for the reformer 12 to reach 700° C. after starting, but it takes approximately one hour for the CO shifter 15a to reach 200° C. Accordingly, although the reformer 12 reaches the normal operating temperature in a short time, the fuel processor 10 is unable to operate until the CO shifter 15a reaches the normal operating temperature. In other words, a hydrogen gas can be produced in the reformer 12 in approximately 20 minutes after the start of the fuel processor 10, but the fuel processor 10 requires a one hour start up time in order to reduce the CO component in the gas below 5,000 ppm.

Accordingly, in order to reduce the start up time for normal operation of the fuel processor 10, there is a need to develop a method of early heating for the CO shifter 15a.

### SUMMARY OF THE INVENTION

To solve the above and/or other problems, the present invention provides a fuel processor having a shift reactor with an improved warming up structure to reduce an initial heating time of the shift reactor and a method of operating the fuel processor.

According to an aspect of the present invention, there is provided a fuel processor comprising: a reformer that extracts hydrogen gas through a reaction between a hydrocarbon fuel source and water; a shift reactor that transforms CO included in a reformer gas discharged from the reformer to CO₂ by reacting CO with water; a combustion reactor which is installed to contact an outer circumference of the shift reactor and has a combustion catalyst disposed along a gas flow channel formed in the combustion reactor; a CO remover that removes CO included in the reformer gas discharged from the shift reactor by reacting CO with oxygen; and an air supply unit that selectively supplies air to the shift reactor, the combustion reactor, and the CO remover.

The fuel processor may further comprise: a first valve for controlling the supply of oxygen to the combustion reactor from the air supply unit; a second valve for controlling the supply of the reformer gas discharged from the reformer to at least one of the shift reactor and the combustion reactor; and a third valve for controlling the supply of shift gas so that the shift gas discharged from the shift reactor is supplied to at least one of the CO remover and the combustion reactor.

The combustion catalyst of the combustion reactor may comprise at least one selected from the group consisting of Pt, Pd, Ru, Au, and an oxide of these metals.

According to an aspect of the present invention, there is provided a method of operating a fuel processor comprising: supplying a hydrocarbon fuel source and water to a reformer; and supplying a reformer gas discharged from the reformer together with air to a combustion reactor until the temperature of the shift reactor reaches a normal operating temperature. At this point, if the temperature of the shift reactor reaches above the normal operating temperature, only air may be supplied to the combustion reactor.

According to another aspect of the present invention, there is provided a method of operating the fuel processor comprising: after supplying a hydrocarbon fuel source and water to a reformer, supplying a reformer gas discharged from the reformer together with air to the combustion reactor; supplying the reformer gas to the shift reactor after stopping the supply of the reformer gas and air to the combustion reactor when the temperature of the shift reactor reaches above an operable temperature; and supplying the shift gas discharged from the shift reactor together with air to the combustion reactor until the temperature of the shift reactor reaches the normal operating temperature. At this point, only air may be supplied to the combustion reactor when the temperature of the shift reactor reaches above the normal operating temperature.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic drawing illustrating the principle of electricity generation of a conventional fuel cell;

FIG. 2 is a block diagram showing a configuration of a conventional fuel processor that processes a fuel that is to be supplied to a fuel cell;

FIG. 3 is a block diagram of a configuration of a fuel processor according to an embodiment of the present invention;

FIG. 4A is a schematic drawing (cross-sectional view?) of a combustion reactor that can be applied to the present invention;

FIG. 4B is a cross-sectional view of a structure of a fuel processor according to another embodiment of the present invention;

FIG. 5 is a block diagram showing a configuration of a fuel processor according to another embodiment of the present invention;

FIG. 6 is a flow chart for explaining a method of operating a fuel processor according to another embodiment of the present invention;

FIG. 7 is a flow chart for explaining a method of operating a fuel processor according to another embodiment of the present invention; and

FIG. 8 is a graph showing the temperature variations of a reformer and a shift reactor when a fuel processor is started according to the operating method of FIG. 7.

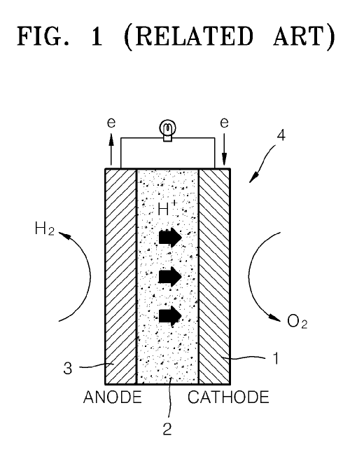

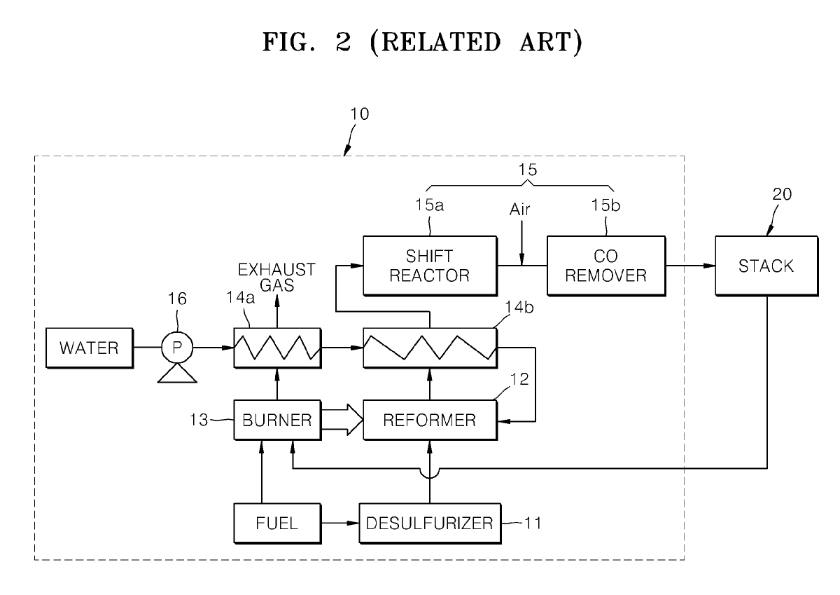

### DETAILED DESCRIPTION OF THE INVENTION

The present invention will now be described more fully with reference to the accompanying drawings in which exemplary embodiments of the invention are shown.

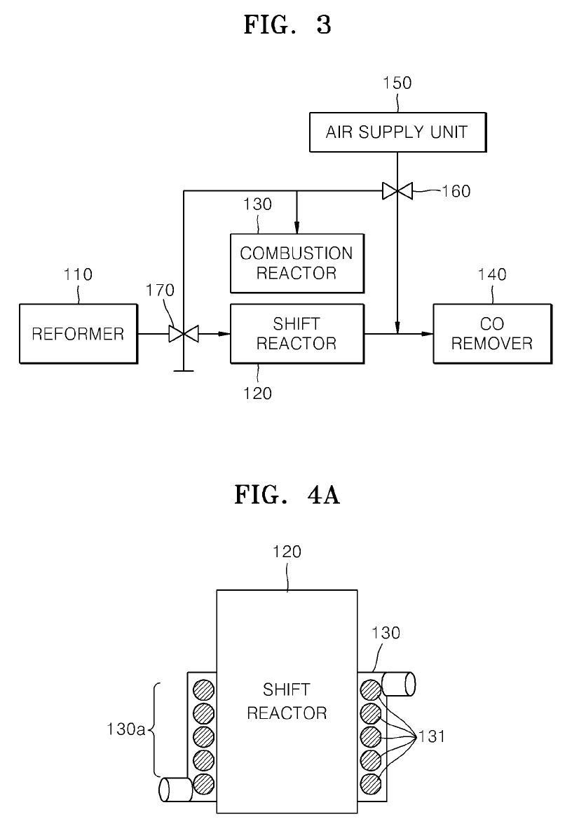

FIG. 3 is a block diagram of a configuration of a fuel processor 100 according to an embodiment of the present invention. Hydrogen extracted from a hydrocarbon group material fuel source such as a natural gas is supplied to a stack (not shown).

The fuel processor 100 basically has a structure in which a reformer 110, a shift reactor 120, a combustion reactor 130, a CO remover 140, an air supply unit 150, a first valve 160, and a second valve 170 are included. Although not shown, the fuel processor 100 can further include a desulfurizer for removing sulfur components which are odorants included in the hydrocarbon group material fuel source such as a natural gas.

A hydrogen extraction process is performed in the reformer 110. That is, the reformer 110 produces hydrogen through a chemical reaction 1 as indicated below by applying heat and steam to a hydrocarbon group material fuel source gas.

CH₄+2H₂O→CO₂+4H₂ [Chemical reaction 1]

Through the above reaction, the reformer 110 produces CO₂ and H₂ as products and additionally produces CO and H₂O. The gas produced by the operation of the reformer 110 is referred to as a reformer gas.

The shift reactor 120 reduces the concentration of CO in the reformer gas discharged from the reformer 110 since CO can greatly hinder the function of a fuel cell by poisoning electrodes of a stack. CO is transformed to CO₂ and H₂ by reacting with water through a chemical reaction 2 indicated below.

CO+H₂O→CO₂+H₂ [Chemical reaction 2]

A gas produced by the operation of the shift reactor 120 is referred to as a shift gas. At a normal operating temperature of the shift reactor 120, the content of CO in the shift gas is 5,000 ppm or less. The normal operating temperature that can be applied to the shift reactor 120 according to the present embodiment is 200° C.-300° C.

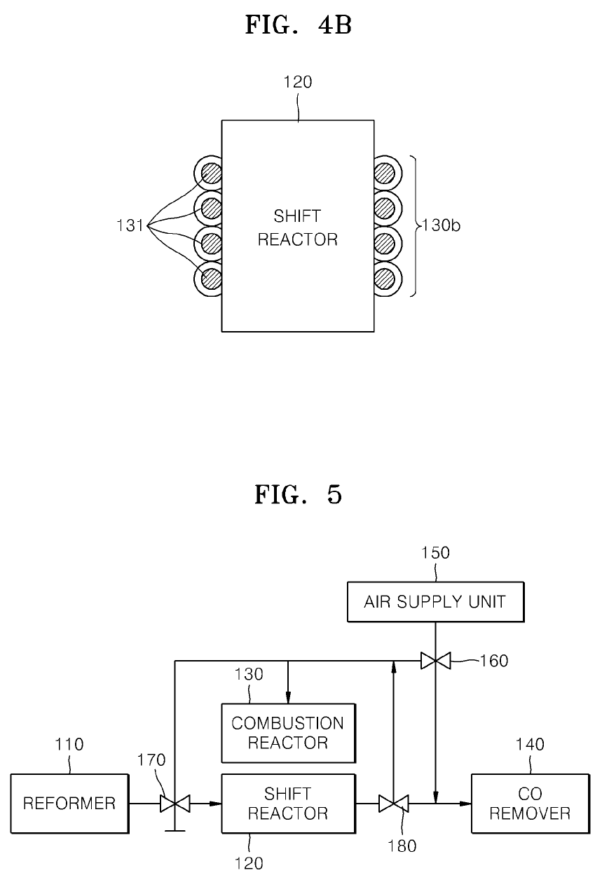

The combustion reactor 130 is installed to contact an outer circumference of the shift reactor 120 and includes a gas flow channel therein. A combustion catalyst 131 (refer to FIG. 4A) is disposed along the gas flow channel. Any catalyst that can promote the combustion reaction, by which heat is rapidly generated through a reaction between the reformer gas and oxygen, can be the combustion catalyst 131 of the combustion reactor 130 according to the present embodiment. At least one catalyst selected from the group consisting of Pt, Pd, Ru, Au, and an oxide of these metals can be the combustion catalyst 131 of the combustion reactor 130 according to the present embodiment.

The combustion reactor 130 that can be applied to the present embodiment can have any shape as long as the combustion reactor 130 can be installed to contact an outer circumference of the shift reactor 120 so that combustion reaction heat of the combustion reactor 130 can be transmitted to the shift reactor 120. Preferable examples of the combustion reactor 130 that can be applied in the present invention are shown in FIGS. 4A and 4B. Referring to FIGS. 4A and 4B, the combustion reactor 130 can be formed in a cylindrical shape 130a or a tube shape 130b that surrounds an outer circumference of the shift reactor 120. This shape can efficiently transmit heat generated through a combustion reaction in the combustion reactor 130 to the shift reactor 120 in a short time.

The CO remover 140 reduces the content of CO in the gas supplied to the stack to below 10 ppm, and chemical reactions 3 and 4 indicated below are performed in the CO remover 140.

CO+½O₂→CO₂ [Chemical reaction 3]

CO+3H₂→CH₄+H₂O [Chemical reaction 4]

At this point, oxygen required for a preferential oxidation (PROX) reaction (chemical reaction 3) is provided from the air supply unit 150.

The first valve 160 is formed to control the amount of oxygen supplied to the combustion reactor 130 or the CO remover 140 from the air supply unit 150, and the second valve 170 is formed to control the supplying amount of reformer gas discharged from the reformer 110 to the shift reactor 120 or the combustion reactor 130.

Air (oxygen) supplied to the CO remover 140 from the first valve 160 is used to reduce the concentration of CO in the reformer gas by transforming CO to CO₂ through chemical reaction 3 as shown above. That is, the first valve 160 controls the amount of air supplied to the CO remover 140 from the air supply unit 150.

The first valve 160 also supplies air to the combustion reactor 130 so that the combustion reactor 130 can rapidly generate heat through a combustion reaction of the reformer gas. At this point, in the present embodiment, the first valve 160 may be controlled such that the amount of oxygen supplied to the combustion reactor 130 from the air supply unit 150 before the temperature of the shift reactor 120 reaches a normal operating temperature satisfies equation 1 indicated below.

0.1<volume of oxygen/(volume of hydrogen+volume of CO)<2 [Equation 1]

This requirement is for the combustion reactor 130 to efficiently burn the reformer gas supplied from the reformer 110 to the combustion reactor 130.

The second valve 170 supplies the reformer gas generated by the operation of the reformer 110 to the combustion reactor 130 so that the combustion reactor 130 can rapidly generate heat through a combustion reaction between air provided from the air supply unit 150 and the reformer gas.

At this point, in the present embodiment, the second valve 170 may supply the reformer gas to the combustion reactor 130 until the temperature of the shift reactor 120 reaches a normal operating temperature. If the temperature of the shift reactor 120 exceeds the normal operating temperature, the second valve 170 supplies the reformer gas to the shift reactor 120, and the shift reactor 120 that receives the reformer gas transforms CO to CO₂ by reacting CO with water as per chemical reaction 2.

In the present embodiment, the normal operating temperature of the shift reactor 120 is 200 to 300° C.

If the shift gas is continuously supplied to the combustion reactor 130 in spite of the temperature of the shift reactor 120 having exceeded the normal operating temperature, the combustion reaction in the combustion reactor 130 is continued, and accordingly, heat generated from the combustion reaction increases the temperature of the shift reactor 120. This is undesirable since a catalyst in the shift reactor 120 can be degraded due to high temperature.

If the reformer gas is not supplied to the combustion reactor 130 since the temperature of the shift reactor 120 has exceeded the normal operating temperature, the temperature of the combustion reactor 130 is reduced by the room temperature air supplied from the air supply unit 150, and thus, rapid increase in the temperature of the shift reactor 120 is prevented.

FIG. 5 is a block diagram showing a configuration of a fuel processor 100 according to another embodiment of the present invention. The fuel processor 100 has a structure which is basically as the same as the structure of FIG. 3, and in which a reformer 110, a shift reactor 120, a combustion reactor 130, a CO remover 140, an air supply unit 150, a first valve 160, and a second valve 170 are included. Although not shown, a desulfurizer can further be included to remove odorant sulfur components included in a fuel source such as a natural gas.

The fuel processor 100 of FIG. 5 additionally includes a third valve 180 for controlling the amount of shift gas discharged from the shift reactor 120 to be supplied to the CO remover 140 or the combustion reactor 130.

The hydrogen extraction process is performed in the reformer 110. That is, the reformer 110 produces hydrogen through a chemical reaction 1 as indicated above by applying heat and steam to a hydrocarbon group material fuel source gas.

The shift reactor 120 transforms CO to CO₂ by reacting CO with water as per the chemical reaction shown above.

The combustion reactor 130 can be installed to contact an outer circumference of the shift reactor 120 so that combustion reaction heat of the combustion reactor 130 can be transmitted to the shift reactor 120. A gas flow channel is formed in the combustion reactor 130, and a combustion catalyst 131 is disposed along the gas flow channel. Any catalyst that can promote the combustion reaction, by which heat is rapidly generated through a reaction between the reformer gas and oxygen, can be the combustion catalyst 131 of the combustion reactor 130 according to the present embodiment. At least one catalyst selected from the group consisting of Pt, Pd, Ru, Au, and an oxide of these metals may be the combustion catalyst 131 of the combustion reactor 130 according to the present embodiment.

The combustion reactor 130 that can be applied to the present embodiment can have any shape as long as the combustion reactor 130 can be installed to contact an outer circumference of the shift reactor 120 so that combustion reaction heat of the combustion reactor 130 can be transmitted to the shift reactor 120. Preferable examples of the combustion reactor 130 that can be applied in the present invention are shown in FIGS. 4A and 4B. Referring to FIGS. 4A and 4B, the combustion reactor 130 can be formed in a cylindrical shape 130a or a tube shape 130b that surrounds an outer circumference of the shift reactor 120. This shape can efficiently transmit heat generated through a combustion reaction in the combustion reactor 130 to the shift reactor 120 in a short time.

The CO remover 140 reduces the content of CO in the gas supplied to the stack to below 10 ppm, and chemical reactions 3 and 4 indicated above are performed in the CO remover 140.

At this point, oxygen required for a preferential oxidation (PROX) reaction (chemical reaction 3) is provided from the air supply unit 150.

The first valve 160 is formed to control the amount of oxygen supplied to the combustion reactor 130 or the CO remover 140 from the air supply unit 150, and the second valve 170 is formed to control the amount of reformer gas discharged from the reformer 110 to be supplied to the shift reactor 120 or the combustion reactor 130. The third valve 180 is formed to control the amount of shift gas discharged from the shift reactor 120 to be supplied to the CO remover 140 or the combustion reactor 130.

Air (oxygen) supplied to the CO remover 140 from the first valve 160 is used to reduce the concentration of CO in the reformer gas by transforming CO to CO₂ as per chemical reaction 3 shown above. That is, the first valve 160 controls the amount of air supplied to the CO remover 140 from the air supply unit 150.

The first valve 160 also supplies air to the combustion reactor 130 so that the combustion reactor 130 can rapidly generate heat through a combustion reaction of the reformer gas. At this point, in the present embodiment, the first valve 160 may be controlled such that the amount of oxygen supplied to the combustion reactor 130 from the air supply unit 150 before the temperature of the shift reactor 120 reaches a normal operating temperature satisfies equation 1 shown above.

This is required for the combustion reactor 130 to efficiently burn the reformer gas supplied from the reformer 110 to the combustion reactor 130.

The second valve 170 supplies the reformer gas generated by the operation of the reformer 110 to the combustion reactor 130 so that the combustion reactor 130 can rapidly generate heat through a combustion reaction between air provided from the air supply unit 150 and the reformer gas.

At this point, in the present embodiment, the second valve 170 may supply the reformer gas to the combustion reactor 130 until the temperature of the shift reactor 120 reaches an operable temperature. If the operable temperature of the shift reactor 120 exceeds the normal operating temperature, the second valve 170 supplies the reformer gas to the shift reactor 120, and the shift reactor 120 that receives the reformer gas transforms CO to CO₂ by reacting CO with water as per chemical reaction 2.

In the present embodiment, the operable temperature of the shift reactor 120 is different from the normal operating temperature at which the CO content in the shift gas discharged from the shift reactor 120 is 5,000 ppm or less, and means an operable temperature range from 80 to 150° C. at which chemical reaction 2 can be generated in the shift reactor 120. The CO content in the shift gas discharged from the shift reactor 120 which is operated in the operable temperature range from 80 to 150° C. exceeds 5,000 ppm.

The third valve 180 supplies air provided from the air supply unit 150 and the shift gas generated from the operation of the shift reactor 120 to the combustion reactor 130 so that heat can be rapidly generated in the combustion reactor 130 through a combustion reaction.

In the present embodiment, if the temperature of the shift reactor 120 exceeds the operable temperature, the third valve 180 controls the shift gas discharged from the shift reactor 120 to be supplied to the combustion reactor 130 until the temperature of the shift reactor 120 increases to the normal operating temperature. At this point, if the temperature of the shift reactor 120 reaches the normal operating temperature, the supply of the shift gas to the combustion reactor 130 is stopped, and the shift gas supply is controlled so that the shift gas discharged from the shift reactor 120 can be supplied to the CO remover 140.

If the shift gas is continuously supplied to the combustion reactor 130 in spite of the temperature of the shift reactor 120 having exceeded the normal operating temperature, the combustion reaction in the combustion reactor 130 is continued, and accordingly, heat generated from the combustion reaction increases the temperature of the shift reactor 120. This is undesirable since a catalyst in the shift reactor 120 can be degraded due to high temperature.

If the reformer gas is not supplied to the combustion reactor 130 since the temperature of the shift reactor 120 has exceeded the normal operating temperature, the temperature of the combustion reactor 130 is reduced by the room temperature air supplied from the air supply unit 150, and thus, rapid increase in the temperature of the shift reactor 120 is prevented.

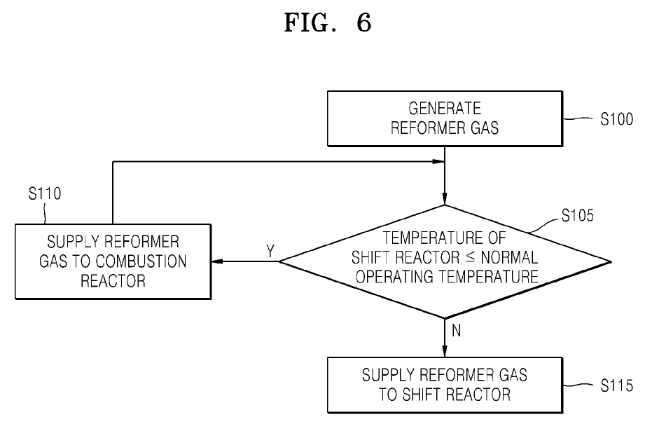

FIG. 6 is a flow chart for explaining a method of operating a fuel processor according to another embodiment of the present invention.

First, hydrogen is produced in the reformer 110 through a chemical reaction between a hydrocarbon group gas that has been introduced thereto as a fuel source and steam according to chemical reaction 1 indicated above (S100).

In the reformer 110, not only CO₂ and H₂ as products but also CO and H₂O as by-products are produced through chemical reaction 1 in operation S100. When the reformer gas is generated, the temperature of the shift reactor 120 is measured to determine whether it is a normal operating temperature or not (S105). At this point, the normal operating temperature is the temperature of the shift reactor 120 at which the content of CO in the shift gas discharged from the shift reactor 120 is 5,000 ppm or less, and preferably is 200 to 300° C.

If the temperature of the shift reactor 120 is confirmed as being lower than the normal operating temperature through operation S105, the reformer gas and air are supplied to a combustion reactor 130 that is installed contacting an outer circumference of the shift reactor 120 and has a gas flow channel therein, and in which a catalyst is disposed along the gas flow channel (S110).

In the present embodiment, the supply of oxygen to the combustion reactor 130 in operation S110 may be controlled to satisfy equation 1 shown above.

This is required for the combustion reactor 130 to efficiently burn the reformer gas supplied to the combustion reactor 130 from the reformer 110.

If the temperature of the shift reactor 120 is the normal operating temperature determined through operation S105, the reformer gas is supplied to the shift reactor 120.

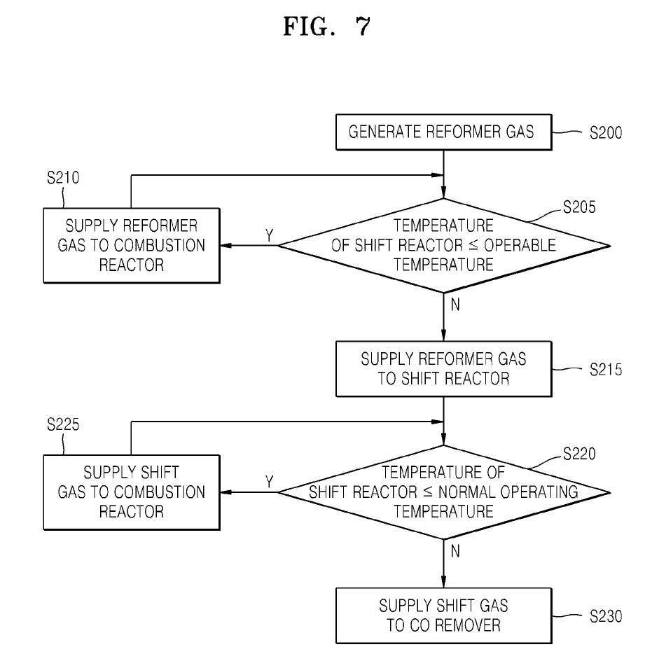

FIG. 7 is a flow chart for explaining a method of operating a fuel processor according to another embodiment of the present invention.

First, hydrogen is produced in the reformer 110 through a chemical reaction between a hydrocarbon group gas that has introduced thereto as a fuel source and steam according to chemical reaction 1 shown above (S200).

In the reformer 110, not only CO₂ and H₂ as products but also CO and H₂O as by-products are produced through chemical reaction 1 in operation S200. When the reformer gas is generated, the temperature of the shift reactor 120 is measured to determine whether it is an operable temperature or not (S205). In the present embodiment, the operable temperature of the shift reactor 120 is different from the normal operating temperature at which the CO content in the shift gas discharged from the shift reactor 120 is 5,000 ppm or less, and means an operable temperature range from 80 to 150° C. at which the chemical reaction 2 can be generated in the shift reactor 120. The CO content in the shift gas discharged from the shift reactor 120 which is operated in the operable temperature range from 80 to 150° C. exceeds 5,000 ppm.

If the temperature of the shift reactor 120 is confirmed as being lower than the operable temperature through operation S205, the reformer gas and air are supplied to a combustion reactor 130, which is installed contacting an outer circumference of the shift reactor 120 and has a gas flow channel therein, and in which a catalyst is disposed along the gas flow channel (S210).

The supply of oxygen to the combustion reactor 130 in operation S210 may be controlled to satisfy equation 1 indicated above.

This is required for the combustion reactor 130 to efficiently burn the reformer gas supplied to the combustion reactor 130 from the reformer 110.

If the temperature of the shift reactor 120 is determined to be higher than an operable temperature through operation S205, after supplying the reformer gas to the shift reactor 120 (S215), it is confirmed whether the temperature of the shift reactor 120 is a normal operating temperature or not (S220). At this point, the normal operating temperature is the temperature of the shift reactor 120 at which the CO content in the shift gas discharged from the shift reactor 120 is 5,000 ppm or less, and preferably is 200 to 300° C.

If the temperature of the shift reactor 120 is confirmed to be a normal operating temperature through operation S220, after supplying the reformer gas to the shift reactor 120, the shift gas generated from the shift reactor 120 is supplied to the combustion reactor 130 together with air (S225).

In the operation S225, the supply of air to the combustion reactor 130 may be controlled to satisfy equation 1 shown above.

If the temperature of the shift reactor 120 is higher than the normal operating temperature as determined through operation S220, the shift gas is no longer supplied to the combustion reactor 130, but is supplied to the CO remover 140 (S230).

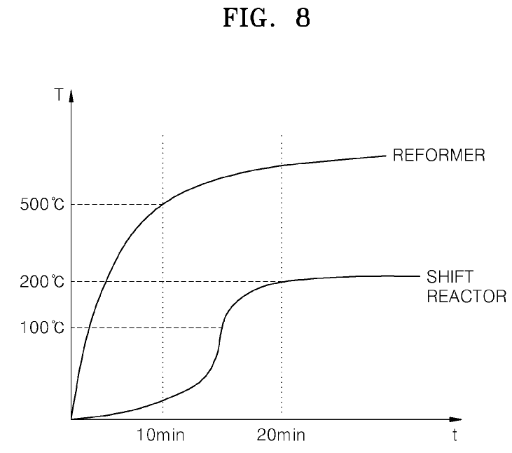

FIG. 8 is a graph showing the inner temperature variations of a reformer and a shift reactor when a fuel processor is started according to the operating method of FIG. 7. At this point, 2.5 g of Pd/Al₂O₃ (0.3 wt % Pd) is used as a combustion catalyst in a combustion reactor of the fuel processor.

Referring to FIG. 8, the inner temperature of the reformer is increased to 500° C. within 10 minutes using an exclusive burner installed in the reformer. It can be seen that as the temperature of the reformer increases, the temperature of the shift reactor also gradually increases. This is because heat of the reformer is transmitted to the shift reactor since the shift reactor is installed to contact an outer circumference of the reformer.

When the temperature of the reformer reaches 500° C., the reformer gas is produced in the reformer through a reaction between a hydrocarbon group gas that has been introduced thereto as a fuel source and steam. It can be seen from FIG. 8 that when the reformer gas is produced from the reformer as the temperature of the reformer increased to 500° C., the inner temperature of the shift reactor is rapidly increased to an operable temperature of 100° C. in a few minutes. This is because heat generated from the combustion reactor that receives the reformer gas and air increases the temperature of the shift reactor that contacts the combustion reactor instead of only using the heat generated from the shift reactor itself.

Although the production of the reformer gas has begun by increasing the temperature of the reformer to 500° C., since the inner temperature of the shift reactor has not reached the operable temperature of 100° C., the reformer gas is not supplied to the shift reactor, but is supplied to the combustion reactor installed at an outer circumference of the shift reactor.

When the temperature of the shift reactor reaches the operable temperature of 100° C., the reformer gas produced from the reformer is supplied to the shift reactor and not to the combustion reactor, and thus, a shift gas as a reaction resultant is produced from the shift reactor. The shift gas produced from the shift reactor is supplied to the combustion reactor together with air.

As shown in FIG. 8, the inner temperature of the shift reactor rapidly increases to a normal operating temperature of 200° C. in a few minutes. This is due to the self reaction heat of the shift reactor that receives the reformer gas and the heat transmitted from the combustion reactor in which a combustion reaction between the shift gas and air is performed.

When the temperature of the shift reactor reaches the normal operating temperature of 200° C., as shown in FIG. 8, it is seen that the temperature of the shift reactor is maintained at the normal operating temperature. This is because, when the temperature of the shift reactor reaches the normal operating temperature of 200° C., the shift gas produced from the shift reactor is not further supplied to the combustion reactor but is instead supplied to the CO remover, and room temperature oxygen is supplied to the combustion reactor, thus, the inner temperature of the combustion reactor is decreased. Accordingly, the temperature of the shift reactor is increased above the normal operating temperature of 200° C. by generating an exothermal reaction that converts CO included in the reformer gas into CO₂, however, the normal operating temperature is maintained due to the combustion reactor installed to contact the outer circumference of the shift reactor.

The fuel processor according to the present invention has the following advantages.

First, since a combustion reactor that generates high combustion reaction heat is installed to contact an outer circumference of a shift reactor, the shift reactor can be rapidly heated during a start-up of the fuel processor. Thus, a time required for the fuel processor to reach a normal operation can be greatly reduced.

Second, since the combustion reactor for transmitting heat to the shift reactor is installed to contact an outer circumference of the shift reactor as an additional apparatus separate from the shift reactor, by-products of the combustion reactor do not affect a catalyst system of the shift reactor during performing of an exothermic reaction.

Third, since a waiting time for an initial start-up is reduced, costs for re-starting are reduced when the fuel processor is stopped, for example, for maintenance purposes.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A fuel processor comprising:
a reformer that extracts hydrogen gas through a reaction between a hydrocarbon fuel source and water;
a shift reactor that transforms CO included in a reformer gas discharged from the reformer to CO₂ by reacting CO with water;
a combustion reactor which is installed to contact an outer circumference of the shift reactor and has a combustion catalyst disposed along a gas flow channel formed in the combustion reactor;
a CO remover that removes CO included in the reformer gas discharged from the shift reactor by reacting CO with oxygen; and
an air supply unit that selectively supplies air to the shift reactor, the combustion reactor, and the CO remover.

2. The fuel processor of claim 1, further comprising:
a first valve for controlling the supply of oxygen to the combustion reactor from the air supply unit; and
a second valve for controlling the supply of the reformer gas discharged from the reformer to at least one of the shift reactor and the combustion reactor.

3. The fuel processor of claim 2, wherein the second valve controls the reformer gas discharged from the reformer to be supplied to the combustion reactor until the temperature of the shift reactor reaches the normal operating temperature, and
when the temperature of the shift reactor is above the normal operating temperature, the second controls the reformer gas discharged from the reformer to be supplied to the shift reactor.

4. The fuel processor of claim 3, wherein, until the temperature of the shift reactor reaches the normal operating temperature, the first valve controls the supply of oxygen to the combustion reactor from the air supply unit to satisfy the following equation,
0.1<volume of oxygen/(volume of hydrogen+volume of CO)<2

5. The fuel processor of claim 2, further comprising a third valve for controlling the supply of shift gas so that the shift gas discharged from the shift reactor is supplied to at least one of the CO remover and the combustion reactor.

6. The fuel processor of claim 5, wherein the third valve controls the shift gas discharged from the shift reactor to be supplied to the combustion reactor when the temperature of the shift reactor is above an operable temperature and below the normal operating temperature, and
the third valve controls the shift gas discharged from the shift reactor to be supplied to the CO remover when the temperature of the shift reactor is above the normal operating temperature.

7. The fuel processor of claim 6, wherein, until the temperature of the shift reactor reaches the normal operating temperature, the first valve controls the supply of oxygen to the combustion reactor from the air supply unit to satisfy the following equation,
0.1<volume of oxygen/(volume of hydrogen+volume of CO)<2

8. The fuel processor of claim 1, wherein the combustion catalyst of the combustion reactor comprises at least one selected from the group consisting of Pt, Pd, Ru, Au, and an oxide of these metals.

9. The fuel processor of claim 1, wherein the combustion reactor has a cylindrical shape or a tube shape and is installed to contact an outer circumference of the shift reactor.

10. The fuel processor of claim 6, wherein the combustion reactor has an operable temperature range of from 85 to 150° C.

11. The fuel processor of claim 3, wherein the combustion reactor has a normal operating temperature range of from 200 to 300° C.

12. A method of operating a fuel processor comprising:
(a) supplying a hydrocarbon fuel source and water to a reformer that extracts hydrogen gas through a chemical reaction between the hydrocarbon fuel source and water; and
(b) supplying a reformer gas discharged from the reformer as a result of the chemical reaction between the hydrocarbon fuel source and water together with air to a combustion reactor, which is installed to contact an outer circumference of a shift reactor and comprises a combustion catalyst disposed along a gas flow channel formed therein, until the temperature of the shift reactor reaches a normal operating temperature.

13. The method of claim 12, further comprising (c) supplying only air to the combustion reactor when the temperature of the shift reactor is above the normal operating temperature after operation (b).

14. The method of claim 12, wherein, in operation (b), the amount of oxygen supplied to the shift reactor satisfies the following equation.
0.1<volume of oxygen/(volume of hydrogen+volume of CO)<2

15. The method of claim 12, wherein the combustion catalyst of the combustion reactor comprises at least one selected from the group consisting of Pt, Pd, Ru, Au, and an oxide of these metals.

16. The method of claim 12, wherein the combustion reactor has a normal operating temperature range of from 200 to 300° C.

17. A method of operating a fuel processor comprising:
(a) supplying a hydrocarbon fuel source and water to a reformer that extracts hydrogen gas through a chemical reaction between the hydrocarbon fuel source and water;
(b) supplying a reformer gas discharged from the reformer as a result of the chemical reaction between the hydrocarbon fuel source and water together with air to a combustion reactor, which is installed to contact an outer circumference of a shift reactor and comprises a combustion catalyst disposed along a gas flow channel formed therein, until the temperature of the shift reactor reaches a normal operating temperature;
(c) supplying the reformer gas to the shift reactor after stopping the supply of the reformer gas and air to the combustion reactor when the temperature of the shift reactor is above an operable temperature after operation (b); and
(d) supplying the shift gas discharged from the shift reactor through operation (c) together with air to the combustion reactor until the temperature of the shift reactor reaches the normal operating temperature.

18. The method of claim 17, after operation (d), further comprising supplying only air to the combustion reactor when the temperature of the shift reactor is above the normal operating temperature.

19. The method of claim 17, wherein, in operation (b), the amount of oxygen supplied to the shift reactor satisfies the following equation.
0.1<volume of oxygen/(volume of hydrogen+volume of CO)<2

20. The method of claim 17, wherein the combustion catalyst of the combustion reactor comprises at least one selected from the group consisting of Pt, Pd, Ru, Au, and an oxide of these metals.

21. The method of claim 17, wherein the combustion reactor has an operable temperature range of from 85 to 150° C.

22. The method of claim 17, wherein the combustion reactor has a normal operating temperature range of from 200 to 300° C.
